(19) United States
(12) Patent Application Publication
(10) Pub. No.: US 2014/0242714 A1
(43) Pub. Date: Aug. 28, 2014

(54) AIR MONITORING SYSTEM AND METHOD

(71) Applicant: BHA Altair, LLC, Franklin, TN (US)

(72) Inventors: Bhalchandra Arun Desai, Smyrna, GA (US); Huong Van Vu, Duluth, GA (US); Michael Adelbert Sullivan, Woodstock, GA (US)

(73) Assignee: BHA Altair, LLC, Franklin, TN (US)

(21) Appl. No.: 13/774,341

(22) Filed: Feb. 22, 2013

(51) Int. Cl. G01N 21/78

(52) U.S. Cl. CPC G01N 21/783
USPC 436/164; 422/83; 422/87

(57) ABSTRACT

A filter element having filter media for filtering air passing therethrough and a detection strip attached thereto comprising a chemical compound that generates a chemical reaction with certain molecules that contact the detection strip.

### BACKGROUND OF THE INVENTION

The subject matter disclosed herein relates to monitoring the quality of air entering through air intakes used for feeding gas turbines.

Gas turbines require large volumes of filtered air for proper operation. The quality of inlet air plays an important role in the degradation of the turbine and may cause damage to the compressor. Every gas turbine has inlet filter elements to filter the air entering into the turbine; however, various corrosive airborne molecules may not be adequately filtered by conventional industrial filters and cause corrosion of the compressor. Hence, it is necessary to monitor the inlet air for the presence of corrosive elements in order to select appropriate filter elements or filtration methods. A common practice is to install corrosion coupons which detect the presence of corrosive elements over a period of time. These coupons may have to be installed for months at a time and, while they provide detailed, quantitative measurements of the amount of corrosives in the air, these measurements are expensive and time consuming. One reason for the expense is that the coupons have to be sent back to a lab for processing and for determining the results.

The discussion above is merely provided for general background information and is not intended to be used as an aid in determining the scope of the claimed subject matter.

### BRIEF DESCRIPTION OF THE INVENTION

A filter element having filter media for filtering air passing therethrough, and a detection strip comprising a chemical compound that generates a chemical reaction with certain airborne molecules that contact the detection strip is disclosed. An exemplary method of using the filter element is also disclosed. An advantage that may be realized in the practice of some disclosed embodiments of the air quality monitoring system and method is an inexpensive and faster means of monitoring intake air.

In one embodiment, a filter element includes a filter media and an attached detection strip. The detection strip comprises a compound that generates a chemical reaction with preselected molecules that contact the detection strip.

In another embodiment, a filter house includes filter elements wherein at least one of the filter elements has an attached detection strip with a compound that forms a chemical reaction with preselected airborne molecules that impact the detection strip.

In another embodiment, a method of monitoring an air filtration system includes installing at least one filter element with an attached detection strip that includes a compound which forms a chemical reaction with preselected molecules. By flowing air through the air filtration system, including exposing the detection strip to the flowing air, the detection strip is monitored for a color change.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a perspective view of an exemplary barrier filter element (or static filter element) having detection strips and color charts/reference attached thereto;

FIG. 2 is a perspective view of an exemplary cartridge filter element having detection strips and color charts attached thereto;

FIG. 3 is a side view diagram of an exemplary filter house; and

FIG. 4 is an exemplary method of monitoring an air flow.

### DETAILED DESCRIPTION OF THE INVENTION

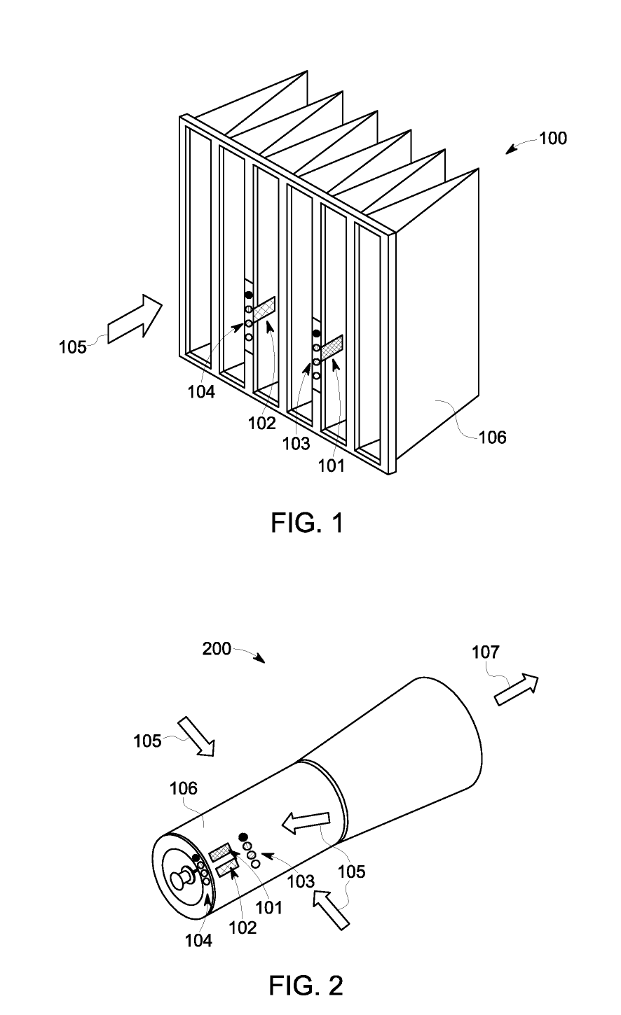

With reference to FIG. 1 and FIG. 2, there are depicted two types of filter elements 100, 200 each having a filter media 106 for filtering air passing therethrough. FIG. 1 depicts a fan folded barrier filter element 100 having a filter media 106 that includes a plurality of folded edges and wherein air typically travels through the filter media 106 in the air direction 105. FIG. 2 depicts a cylindrical cartridge filter element 200 wherein air typically passes through the filter media 106 in air direction 105 from outside of the filter cylinder into a center channel of the filter element 100 and out through an end of the filter element 200 in air direction 107. The shape, geometry, or filter media material, of the filter elements 100, 200 is not essential to the embodiments described herein. The presently described embodiments apply, but are not limited, to W type filters, pocket filters, canister filters, and pulse cartridge filters.

The filter elements 100, 200 each comprise one or more detection strips 101, 102, that are attached to the filter elements 100, 200 in a location, as shown in FIGS. 1-2, such that the detection strips 101, 102 are exposed to, and make contact with, the air flowing through the filter elements 100, 200. The detection strips 101, 102 are treated, impregnated, or coated with a selected chemical compound that is sensitive to a corresponding airborne corrosive substance which may exist in the air flow traveling through the air filter elements 100, 200 that may corrode equipment downstream of the air filter elements 100, 200, such as the gas turbines described above. The detection strips 101, 102 may be attached to the filter elements by an adhesive, or mechanically such as by clips, hooks, and the like. A detection strip 101, 102 comprising, for example, a lead acetate test paper may be used to identify the presence of airborne sulfur-based molecules, such as sulfates and sulfites, that travel through the filter elements. The lead acetate strips may start out as white colored when newly applied to the filter elements and change color during exposure to the airborne sulfur-based molecules that impact the detection strips while passing through the air filter elements 100, 200. A detection strip 101, 102 may be used to identify the presence of airborne chlorine-based molecules, nitrogen-based molecules, or salts that travel through the filter elements. The detection strips 101, 102 may start out with a color that represents an unreacted state of the detection strips 101, 102 when newly applied to the filter elements and change color during exposure to the airborne corrosive molecules that impact the detection strips while passing through the air filter elements 100, 200. Litmus paper used as a detection strip 101, 102 may detect the presence of salts, turning from blue to red under such acidic conditions.

The detection strips 101, 102 progressively change color through known shades at a rate that is proportional to the concentration of airborne corrosive molecules. Depending on the chemical formulation of the detection strips 101, 102, the color changes may range by shades of red, such as pink to brick red, through shades of yellow, or through other color shades. In one embodiment, a gel may be used as a sensitized agent on the detection strip to react with airborne corrosives. The gel may serve to better trap passing corrosive molecules or particles to. In one embodiment, the filter media itself may be treated with compounds that are reactive to the corrosive substances, and so the filter media itself progresses through known color shades as its compounds react with the corrosives in the air flow.

A color chart 103, 104, or color scale, that comprises a plurality, or an array, of permanently colored, progressively shaded regions can be used for side by side visual comparisons with the detection strips 101, 102 to determine a relative concentration of the detected airborne corrosives. The color strip or chart is a made up of chemically inactive material that is not consumed over a period of time. Each of the colored regions corresponds to a known amount of detection strip 101, 102 compound consumed, while reacting with the corrosive molecules in the air flow. The numerical value of the detected concentration may be printed on the color chart 103, 104 adjacent the corresponding color region for easy identification by a user. The color chart 103, 104 may also be attached to the filter element proximate to the detection strip 101, 102. The amount of color change of the detection strip 101, 102 is a function of the total amount of reacted compound on the detection strip 101, 102 and is proportional to both a time duration that the detection strip 101, 102 has been exposed to incoming air and on the concentration of corrosives in the air. A detection strip color change will occur faster with higher airborne concentration of the preselected corrosive molecules. Since the color change is caused by a chemical reaction between the chemical compound used on the detection strip 101, 102 and the airborne corrosive, the color will continue to change the longer that the detection strip 101, 102 is exposed to the incoming air flow until the compound is completely consumed. Thus, a determination of a relative concentration of airborne corrosives will include an amount of time that the detection strip 101, 102 has been exposed to the air flow and a selection of the color region on the color chart 103, 104 that best matches the current color of the detection strip 101, 102. In one embodiment, the comparison can be performed at a known time interval so that a best match between color region and detection strip 101, 102 color corresponds to a specific concentration of the corrosive. In the treated filter media 106 embodiment, the filter media 106 can be inspected for color change characteristics and compared to the color chart 103, 104 instead of a detection strip, or both may be used. In this embodiment, a portion of the filter media 106 may be made impermeable so that its color change is not obscured by dirt, dust, or other debris trapped in the filter media 106.

More than one detection strip 101, 102 may be attached to the filter element 100, 200 for testing the air flowing through it for the presence of multiple corrosive molecules that may be present in the air flow. The additional detection strips 101, 102 may progressively change color through a series of color shades each distinct from others of the detection strips 101, 102, and so may require a separate color chart 103, 104 to be used for comparison purposes. The presence of chlorides and nitrates are typically separately tested from sulfur-based substances and require detection strips that are coated or impregnated with testing compounds that will react to these molecules, as described above. In one embodiment, the detection strips 101, 102 and color charts 103, 104 are attached to the filter element during manufacture of the filter element.

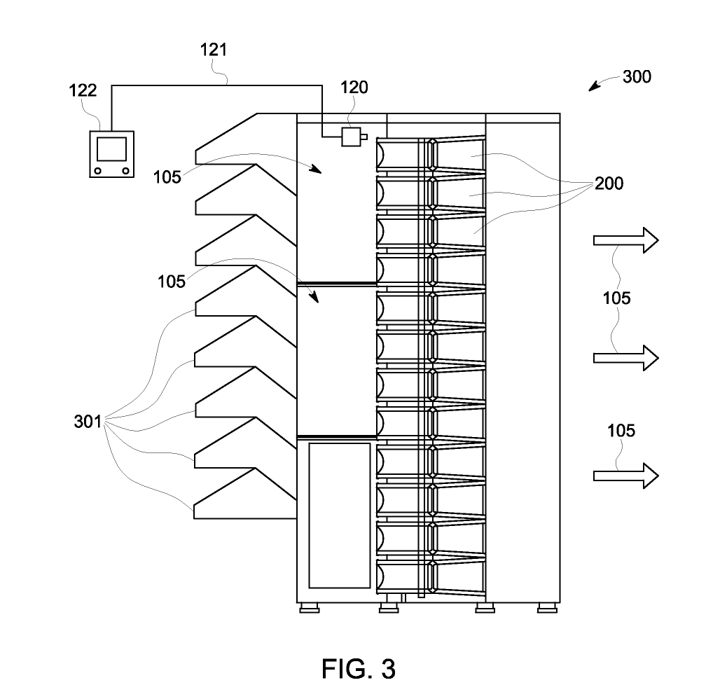

Referring to FIG. 3, there is illustrated a diagram of a filter house 300 comprising a plurality of cylindrical cartridge filters 200. In the perspective of FIG. 3, one column of twelve cartridge-type filters elements 200 are visible, while further columns of the filter elements 200 are disposed in additional columns behind the visible column such that a matrix of the filter elements 200 is disposed therein. A series of eight filter house weather hoods 301 is visible in FIG. 3, arranged vertically and including openings at a bottom portion of each wherein the air flow enters the filter house in air direction 105. Filtered air exits the filter house after passing through filter elements 200 toward the right of the filter house 300 in the perspective view of FIG. 3, eventually reaching downstream gas turbines and other equipment, for example. At least one of the filter elements 200 in filter house 300 includes a detection strip 101, 102 for detecting at least one type of corrosive that may affect operation of downstream equipment utilizing the filtered air. The one or more detection strips 101, 102 disposed in filter house 300 can be monitored by human operators to determine, by visual comparison using a color chart, as described above, whether corrosives are present in the air that may damage, for example, compressors of the gas turbines. The color chart may also be attached to the filter elements proximate to the detection strips to enable easy comparison. In one embodiment, an electronic camera 120, such as a digital video camera or digital still camera, may be positioned in the filter house, aimed at a detection strip and adjacent color chart, which captures a color digital image thereof and transmits the color digital image over electric communication lines 121 to a remote location where a human viewer can remotely perform a visual comparison of the one or more detection strips 101, 102 and one or more color charts 103, 104. The remote location may comprise a processing station with a color monitor 122 for viewing the digital image. In one embodiment, the communication lines 121 may be replaced with a wireless communication system.

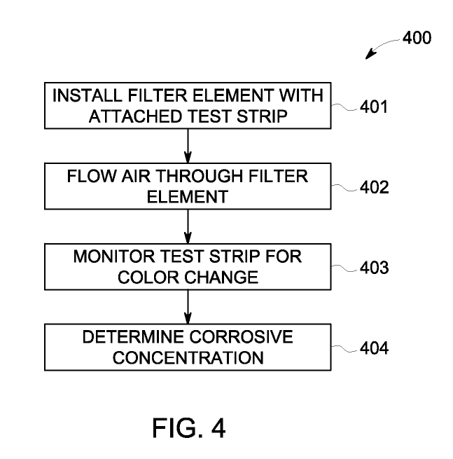

Referring to FIG. 4, in one embodiment, a method 400 applying the present air monitoring system involves monitoring an air filtration system, such as a filter house 300, that comprises multiple filter elements 200. In a first step, step 401, at least one filter element 100 modified with at least one attached chemical detection strip 101, 102 is installed in filter house 300. This step may include recording a time of attachment or, if the detection strip is already attached to the filter element or if the filter media is treated with chemical detection substances, such as during manufacture of the filter element, recording a time of installation of the filter element. Depending on which preselected corrosives are to be monitored, two or more selected detection strips 101, 102 may be attached to filter elements 100, 200 without significantly interfering with air flow. Each of the detection strips 101, 102 may include different compounds for detecting the presence of different types of corrosives present in the air flow, as described above. In addition, this step may include attaching one or more color charts 103, 104 each corresponding to at least one of the detection strips 101, 102 that display a series of colored regions that represent color changes that its corresponding detection strip will undergo as the detection strip 101, 102 is exposed to the incoming air flow that contains airborne corrosives. At step 402, an air flow passes over the detection strips 101, 102 and through the filter elements 200 thereby exposing the detection strips 101, 102 to any airborne corrosives that are present in the air flow. Air flowing through the filter house 300 impacts the one or more detection strips positioned at locations on or near one or more of the filter elements

At step 403, the detection strips 101, 102 are monitored for color changes, which includes visually comparing the color of the detection strip 101, 102 or of the filter media 106 with a corresponding color chart 103, 104 to determine, at step 404, a current reaction amount of airborne corrosive substances with the detection compounds in the detection strip 101, 102 based on a best match basis as between a current color of the detection strip 101, 102 and one of the colored regions on the color chart 103, 104. The color chart 103, 104 includes printed information adjacent such colored regions indicating a numerical amount of reacted compound. The amount of reacted compound corresponds to a relative concentration of the airborne corrosives. A time duration of the monitoring step can be used to calculate a total elapsed time since the detection strips 101, 102 were attached or since the filter elements 200 were installed. The rate of reaction can then be used to determine a level of concentration for the corrosive in the air over the duration. In one embodiment, step 403 is performed at a prescribed time interval wherein the best match color region of the color chart 103, 104 will then directly indicate the numerical concentration of a selected airborne corrosive. The elapsed time may be measured, or scheduled, from a point when the detection strip 101, 102 was first attached to the filter element 200 until the point in time when the comparison is undertaken. Example corrosive agents that may be detected in this manner include sulfur-based substances such as sulfates and sulfites, chlorine based compounds such as chlorides, and nitrogen based compounds such as nitrates. In one embodiment, the detection strips 101, 102 may be wetted by wet swab to dissolve the laden corrosives on the detection strip 101, 102 to better visualize its color. Some corrosives react more when in aqueous stage. It is quite common for a filter element to experience water ingression during rainy season.

In view of the foregoing, embodiments of the invention allow faster and cheaper detection of airborne corrosive substances entering an air intake system such as a filter house. A technical effect is to avoid equipment degradation by taking steps to employ different filter media that counteracts the corrosives or to otherwise prevent the corrosive substances from entering the air intake system.

As will be appreciated by one skilled in the art, aspects of the present invention may be embodied as a system, method, or computer program product. Accordingly, aspects of the present invention may take the form of a hardware embodiment (including firmware, resident software, micro-code, etc.), or an embodiment combining software and hardware aspects that may all generally be referred to herein as a “processing station,” “circuit,” “communication line” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter element comprising:
filter media for filtering air that passes therethrough; and
a detection strip attached to the filter element, the detection strip comprising a compound that generates a chemical reaction with preselected molecules that contact the detection strip.

2. The filter element of claim 1, wherein the compound indicates a presence of the chemical reaction by changing color, and wherein the compound continues to change color so long as the chemical reaction continues.

3. The filter element of claim 2, further comprising an array of color samples attached thereto, each corresponding to one of the changing colors for indicating an amount of the compound consumed as a result of undergoing the chemical reaction.

4. The filter element of claim 3, wherein the molecules are airborne in the air that passes through the filter element.

5. The filter element of claim 4, wherein the detection strip is attached to the filter element in a location such that air passing through the filter element impacts the strip prior to passing through the filter media.

6. The filter element of claim 5, wherein the detection strip is located on the filter element such that air passing through the filter element impacts the strip after passing through the filter media.

7. The filter element of claim 5, wherein the preselected molecules comprise sulfur-based molecules.

8. The filter element of claim 7, further comprising:
a second strip attached to the filter element, the second strip comprising a second compound that generates a second chemical reaction with preselected second molecules that impact the second strip, wherein the second compound indicates a presence of the second chemical reaction by changing color, and wherein the second compound continues to change color so long as the second chemical reaction continues; and
a second array of color samples attached thereto, each corresponding to one of the changing colors of the second compound for indicating an amount of the compound consumed as a result of undergoing the second chemical reaction.

9. The filter element of claim 8, wherein the preselected second molecules comprise chlorine-based molecules and nitrogen-based molecules.

10. A filter house comprising:
a plurality of filter elements each comprising a filter media for filtering air that passes therethrough; and
at least one of the filter elements comprising a detection strip attached thereto, the strip comprising a compound that forms a chemical reaction with preselected airborne molecules that impact the detection strip.

11. The filter house of claim 10, wherein the compound indicates a presence of the chemical reaction by changing its color, and wherein the compound continues to change its color so long as the chemical reaction continues.

12. The filter house of claim 11 further comprising an array of color samples attached thereto, each corresponding to one of the changing colors for indicating a level of the chemical reaction.

13. The filter house of claim 12, wherein the molecules are airborne in air that passes through the filter element, the strip is located on the filter element such that air passing through the filter element impacts the strip prior to passing through the filter element, and wherein the preselected molecules comprise either sulfate molecules, chloride molecules, nitrate molecules, or a combination thereof.

14. The filter house of claim 13, wherein the filter elements each further comprise:
a second strip attached to the filter element, the second strip comprising a second compound that forms a second chemical reaction with preselected second molecules that impact the second strip, wherein the second compound indicates a presence of the second chemical reaction by changing its color, and wherein the second compound continues to change its color so long as the second chemical reaction continues; and
a second array of color samples attached thereto, each corresponding to one of the changing colors of the second compound for indicating a level of the second chemical reaction.

15. A method of monitoring an air filtration system comprising filter elements, the method comprising
installing in the air filtration system at least one of the filter elements having a detection strip attached thereto, the detection strip comprising a compound that forms a chemical reaction with preselected molecules;
flowing air through the air filtration system, including exposing the detection strip to the air flowing through the air filtration system; and
monitoring the detection strip for a color change.

16. The method of claim 15, further comprising:
comparing a current color of the detection strip to a plurality of color samples on a color chart, the plurality of color samples each having a different color, the color chart comprising concentration amount information corresponding to each of the plurality of color samples; and
determining a relative concentration of the preselected molecules in the air including matching the current color of the detection strip with one of the plurality of sample colors.

17. The method of claim 16, wherein the step of determining includes the step of calculating an amount of time elapsed from the time when the detection strip was first attached to the filter element.

18. The method of claim 17, wherein the step of determining includes the step of determining a relative concentration of sulfate, chloride, or nitrate molecules.

19. The method of claim 15, further comprising:
exposing a second detection strip to the air flowing through the air filtration system, the second detection strip comprising a second compound that forms a chemical reaction with preselected second type molecules;
monitoring the second detection strip for a color change; and
determining a relative concentration of the preselected second type molecules in the air including calculating a rate of the color change.

20. The method of claim 19, further comprising:
comparing a current color of the second detection strip to a plurality of color samples on a second color chart, the plurality of color samples on the second color chart each having a different color, the second color chart comprising concentration amount information corresponding to each of the plurality of color samples thereon; and
comparing a current color of the second detection strip with the plurality of samples of the second color chart.
